(19) United States
(12) Patent Application Publication
(10) Pub. No.: US 2022/0236099 A1
(43) Pub. Date: Jul. 28, 2022

(54) QUANTITATIVE DISPENSING SYSTEM

(71) Applicant: A&D COMPANY, LIMITED, Tokyo (JP)

(72) Inventors: Haruna NOGUCHI, Saitama (JP); Yuji FUKAMI, Saitama (JP)

(21) Appl. No.: 17/615,491

(22) PCT Filed: Jun. 4, 2020
(86) PCT No.: PCT/JP2020/022092

§ 371 Date: Nov. 30, 2021

(30) Foreign Application Priority Data
Jun. 7, 2019 (JP) 2019-106755

(51) Int. Cl. G01G 13/12; G01G 19/52; G06F 17/15

(52) U.S. Cl. CPC G01G 13/12; G06F 17/15; G01G 19/52

(57) ABSTRACT

Provided is a quantitative dispensing system includes a supply device for supply a weighing object, and a weighing device including a holding unit to hold the weighing object supplied from the supply device, a load sensor unit to detect a load of the weighing object supplied to the holding unit, and an arithmetic processing unit to calculate a weighed value of the weighing object from a detection result on the load and control an operation of the supply device. The arithmetic processing unit performs control to stop the supply device when a current weighed value becomes not less than a supply stop weight value calculated by subtracting a stop weighed value deviation from a supply target weight value. The stop weighed value deviation is calculated in consideration of a flow rate and a supply pressure of the weighing object and a filter setting in the weighing device.

The present application is a U.S. National Phase of PCT/JP2020/022092 filed on Jun. 4, 2020, claiming priority to Japanese Patent Application No. 2019-106755 filed on Jun. 7, 2019. The disclosure of the PCT Application is hereby incorporated by reference into the present Application.

### TECHNICAL FIELD

The present disclosure relates to a quantitative dispensing system and, more particularly, to a quantitative dispensing system that includes a supply device and a weighing device and weighs out a fluid or powder and granular material in predetermined amounts.

### BACKGROUND ART

Conventionally, there is known a quantitative dispensing apparatus that includes a pump as a supply unit that supplies a weighing object, a vessel as a holding unit that holds a weighing object, a weighing unit that weighs the weight of a weighing object, and a control unit that controls the operation of the supply unit based on a weighing result. This apparatus weighs out a predetermined amount of a weighing object by controlling to stop the supply unit when a predetermined supply target weight value is achieved.

Such a quantitative dispensing apparatus generates a stop signal to stop the supply unit when a weighed value reaches a target supply weighed value. So, a supply amount deviation occurs due to, for example, a response delay between the timing when a stop signal is generated and the timing when the supply of a weighing object actually stops.

The quantitative dispensing system disclosed in Patent Literature 1 calculates the supply amount deviation caused by a response delay until the supply of a weighing object stops based on a flow rate and a response delay time, sets, as a supply stop weight value, the value obtained by subtracting the deviation as a correction weight from a target weight value, and corrects the supply error caused in a weighed value by a response delay from when a stop signal is generated to when the supply of the weighing object actually stops.

### CITATION LIST

### Patent Literature

Patent Literature 1: Japanese Published Unexamined Patent Application No. 2007-003343

### SUMMARY OF INVENTION

### Technical Problem

However, further examination has revealed that a supply amount deviation originates from not only a response delay from the timing of stop control to the timing of the actual stop of the supply unit but also the drop between the stop position of the supply unit and the holding unit, the filter setting in signal processing by a weighing device, a supply pressure at the time of supply from the supply unit to the holding unit, etc. Note that herein, a filter setting means the setting of a so-called response characteristic.

The quantitative dispensing system according to the Patent Literature 1 can handle an excessive supply amount deviation but does not handle an insufficient supply amount deviation. Accordingly, there is demand for a quantitative dispensing system that can more accurately dispense a predetermined amount in consideration of these supply amount deviations.

The present invention has been made in consideration of the above circumstances and has as its object to provide a quantitative dispensing system that can accurately weigh out a weighing object of a supply target weight in consideration of a filter setting in a weighing device and the supply pressure of the weighing object.

### Solution to Problem

In order to achieve the above object, a quantitative dispensing system according to one aspect of the present invention includes a supply device configured to supply a weighing object, and a weighing device that includes a holding unit configured to hold the weighing object supplied from the supply device, a load sensor unit configured to detect a load of the weighing object supplied to the holding unit, and an arithmetic processing unit configured to sequentially calculate a weighed value of the weighing object from a detection result on the load and control an operation of the supply device. The arithmetic processing unit performs control to stop the supply device when a current weighed value becomes not less than a supply stop weight value calculated by subtracting a stop weighed value deviation from a supply target weight value. The stop weighed value deviation is calculated in consideration of a flow rate and a supply pressure at which the supply device supplies the weighing object and a filter setting in the weighing device.

In the above aspect, the weighing device may include a storage unit, the arithmetic processing unit may include a test mode executing unit configured to execute a test mode for changing a flow rate and a filter setting in a plurality of levels, measuring a stop weighed value deviation in each level, calculating a relationship between a flow rate, a filter setting in the weighing device, and a stop weighed value deviation, and storing the relationship in the storage unit, and the arithmetic processing unit may calculate a supply stop weight value based on the relationship between a flow rate calculated by the test mode executing unit, the filter setting, and the stop weighed value deviation when quantitative dispensing is executed.

In the above aspect, a relationship between the flow rate, the filter setting in the device, and the stop weighed value deviation may be stored as a function in the storage unit.

In the above aspect, a relationship between the flow rate, the filter setting in the device, and the stop weighed value deviation may be expressed by

$$δ ( Q ) = a \cdot {Q}^{2} + b \cdot Q$$

where δ is the stop weighed value deviation, Q is a flow rate, b is a coefficient associated with a filter setting, and a is a coefficient associated with a discharge pressure.

In the above aspect, the weighing device may include an analog control unit and the arithmetic processing unit may control the analog control unit to cause the weighing device to control the supply device by analog control.

### Advantageous Effects of Invention

The quantitative dispensing system according to the above aspect can accurately weigh out a weighing object of a supply target weight in consideration of a filter setting in a weighing device and the supply pressure of the weighing object.

### BRIEF DESCRIPTION OF THE DRAWINGS

FIG. 1 is a view illustrating the overall configuration of a quantitative dispensing system according to the first embodiment of the present invention.

FIG. 2 is a configuration block diagram of a weighing device of the same system.

FIG. 3 is a functional block diagram of the arithmetic processing unit of the weighing device of the same system.

FIG. 4 is a graph for explaining the behavior of a weighed value at the time of a supply device stopping in the same system.

FIG. 5 is a graph illustrating the relationship between stop weighed value deviation and flow rate in the same system.

FIG. 6 is a graph illustrating the relationship between stop weighed value deviation after approximation and flow rate in the same system.

FIG. 7 is a flowchart for flow rate function computation processing by the same system.

FIG. 8 is a flowchart for test mode processing by the same system.

FIG. 9 is a flowchart for quantitative dispensing processing by the same system.

### DESCRIPTION OF EMBODIMENTS

The preferred embodiments of the present invention will be described below with reference to the accompanying drawings. However, the present invention is not limited to them.

### EMBODIMENT

### Overall Configuration of System

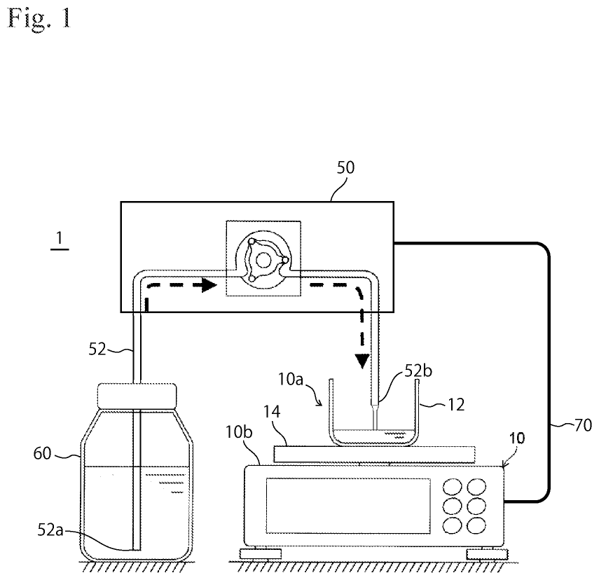

FIG. 1 illustrates the overall configuration of a quantitative dispensing system (hereinafter simply referred to as “system”) 1 according to an embodiment of the present invention. The system 1 is embodied the present invention as a system that dispenses a liquid as a weighing object in predetermined amounts.

The system 1 includes a weighing device and a supply device that supplies a weighing object. In this embodiment, the weighing device is an electronic balance 10. The supply device is a pump 50 that supplies a liquid at a predetermined flow rate.

As is apparent, the electronic balance 10 includes a holding unit 10a that holds the liquid supplied from the pump 50 and an electronic balance body 10b. The electronic balance 10 is connected to the pump 50 via a cable 70 that can transmit analog signals and contact signals. The holding unit 10a includes a vessel 12 that contains a weighing object and a weighing pan 14 on which the vessel is placed.

The pump 50 is, for example, a tube type pump such as a peristatic pump, which operates to externally flatten an elastic tube with a roller so as to squeeze out the liquid inside the tube. One end 52a of a supply tube 52 of the pump 50 is placed inside the liquid retained in a tank 60, and the other end 52b is placed above the holding unit 10a. When the pump 50 operates, the liquid inside the tank 60 is supplied into the vessel 12 of the holding unit 10a at a set flow rate. The pump 50 is configured to enable external control of the flow rate by analog signals, with a current value serving as a controlled value.

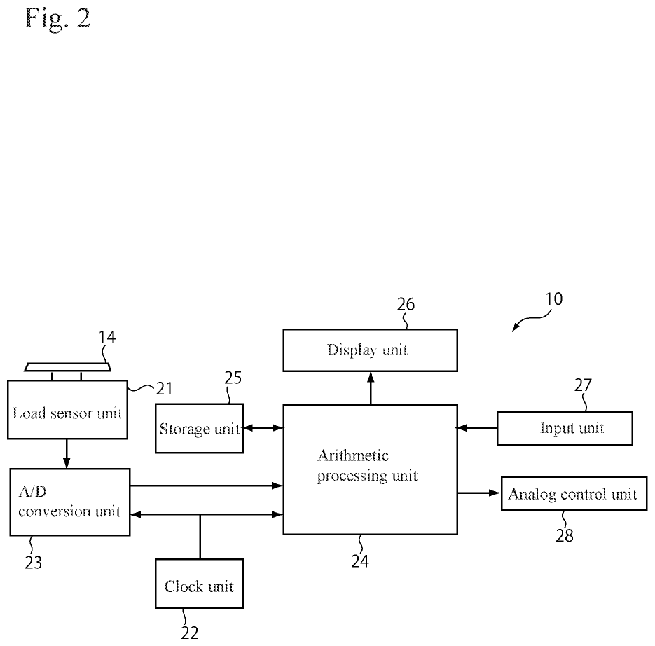

FIG. 2 is a block diagram illustrating the internal structure of the electronic balance 10. The electronic balance 10 includes a load sensor unit 21, a clock unit 22, an A/D conversion unit 23, an arithmetic processing unit 24, a storage unit 25, a display unit 26, an input unit 27, and an analog control unit 28.

The load sensor unit 21 is a load detection mechanism that includes the weighing pan 14 on which the vessel 12, into which a weighing object is to be injected, is placed, and also includes, for example, an electromagnetic balance type sensor or load cell that detects the load of a weighing object. The load sensor unit 21 outputs an analog signal corresponding to a detected load.

The clock unit 22 is, for example, a clock generation circuit that includes a crystal oscillator. The clock unit 22 outputs reference time signals to the A/D conversion unit 23 and the arithmetic processing unit 24 at predetermined intervals. Note that when the A/D conversion unit 23 or the arithmetic processing unit 24 incorporates a unit equivalent to the clock unit 22, there is no need to independently provide the clock unit 22.

The A/D conversion unit 23 is an A/D converter that includes an A/D conversion circuit. The A/D conversion unit 23 digitally converts analog load signals output from the load sensor unit 21 at predetermined intervals based on reference time signals from the clock unit 22 to obtain load data.

The arithmetic processing unit 24 is, for example, a microprocessor (MPU). The basic operation of the arithmetic processing unit 24 is to convert the load data output from the A/D conversion unit 23 into a weighed value W₍ₙ₎ to update the latest weighed value W₍ₙ₎ at predetermined intervals based on reference time signals and cause the storage unit 25 to sequentially store the values. The storage unit 25 includes n storage areas and stores weighed values W₍ₙ₎, W₍ₙ₋₁₎, . . . W₍₂₎, and W₍₁₎ starting from the latest weighed value. When the weighed value W₍ₙ₎ is updated, the oldest weighed value W₍₁₎ is discarded, and W₍ₙ₎, W₍ₙ₋₁₎, . . . W₍₂₎, and W₍₁₎ are newly stored.

The arithmetic processing unit 24 outputs control signals for controlling the pump 50 to the analog control unit 28. The detailed function of the arithmetic processing unit 24 will be described later.

The storage unit 25 is, for example, a rewritable memory such as a RAM or flash memory and stores various types of data and calculation results such as weighed values which are used by the arithmetic processing unit 24. Note that when the MPU incorporates a storage unit, there is no need to independently provide the storage unit 25.

The display unit 26 is, for example, a liquid crystal display. The display unit 26 displays data such as weighing results, and other indications necessary for settings, etc.

The input unit 27 includes, for example, push buttons, a keyboard, and contact input switches. A measurer can input various types of settings such as a filter setting and a flow rate setting at the time of quantitative dispensing and operation instructions for quantitative dispensing via the input unit 27.

Note that the display unit 26 and the input unit 27 may be integrated into one unit so as to be provided as a touch panel type input unit 27.

The analog control unit 28 includes a D/A conversion circuit, a contact mechanism, and an output mechanism. The analog control unit 28 converts a control signal from the arithmetic processing unit 24 into a controlled value of a current value as an analog quantity and outputs the signal to the pump 50 via the cable 70. More specifically, upon receiving a dispensing start signal from the arithmetic processing unit 24, the analog control unit 28 starts the operation of the pump 50 by turning on the contact. Subsequently, the pump 50 outputs with a set controlled value. Upon receiving an instruction to stop the operation of the pump 50 from the arithmetic processing unit 24, the analog control unit 28 stops the operation of the pump 50 by setting the output to 0.

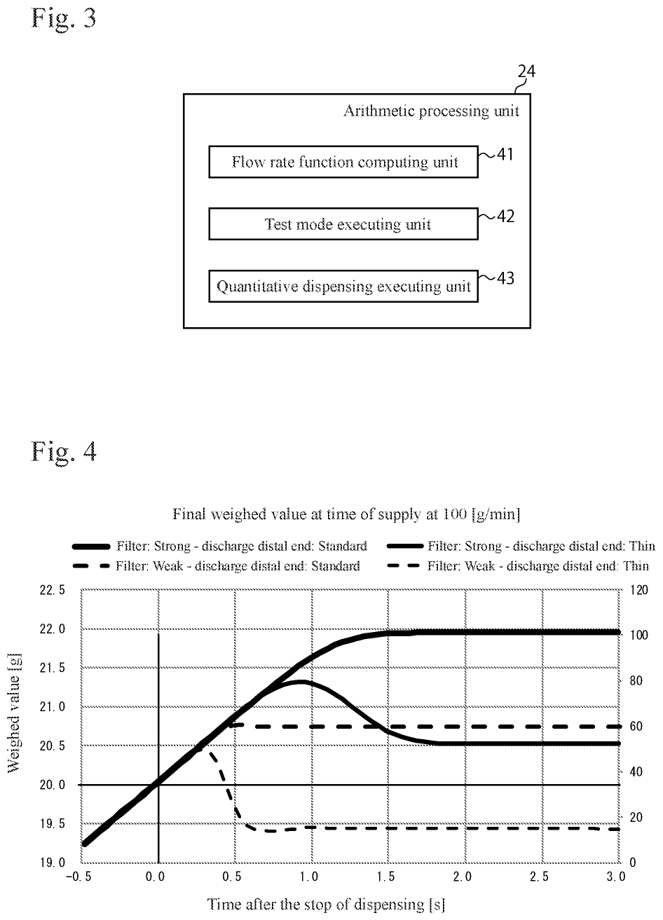

The detailed function of the arithmetic processing unit 24 will be described below. FIG. 3 is a functional block diagram of the arithmetic processing unit 24. The arithmetic processing unit 24 includes a flow rate function computing unit 41, a test mode executing unit 42, and a quantitative dispensing executing unit 43. Each functional unit may be implemented by a program or circuit.

The flow rate function computing unit 41 computes a function between the controlled value output from the analog control unit 28 and the flow rate of a weighing object supplied from the pump 50 and stores the function in the storage unit 25.

The test mode executing unit 42 executes the test mode for changing a flow rate setting and a filter setting in a plurality of levels, measuring the deviation (hereinafter referred to as “stop weighed value deviation”) between a weighed value and a final weighed value at the time of stopping the pump 50 in each step, calculating the relationship between flow rate setting, a filter setting, and a stop weighed value deviation, and storing the relationship in the storage unit 25.

The quantitative dispensing executing unit 43 weighs out a predetermined amount of a weighing object by controlling the operation of the pump 50 at a set flow rate, sequentially calculating the weighed value of the weighing object from the load detection result obtained by the load sensor unit 21, and controlling the supply device to stop when the current weighed value becomes equal to or larger than the supply stop weight value calculated by subtracting a stop weighed value deviation from a supply target weighed value.

(Stop Weighed Value Deviation)

A stop weighed value deviation will be described prior to the description of the operation of the quantitative dispensing system 1. As described above, causes for a stop weighed value deviation include the response delay of the supply device from stop control on the supply device to the actual stop of the supply device, the drop from the discharge unit of the supply device to the holding unit, the filter setting in the weighing device, and the supply pressure of a weighing object from the supply device to the holding unit.

Accordingly, the present inventors have examined in detail the influences of the filter setting in the electronic balance 10 and supply pressure.

The electronic balance 10 has a filter setting that changes display stability in accordance with a measurement environment. As indicated by Table 1, when the filter setting is strong (SLOW), the longer the time it takes to reach the final weighed value in a stable state. As a result, although the time it takes until the display of a measurement value is longer, weighed values do not easily vary and become stable regardless of being influenced by disturbance such as vibration. On the other hand, when the filter setting is weak (FAST), the time it takes for a weighed value to reach the final value shortens. This makes it possible to speed up the reading speed, but a weighed value is susceptible to the influence of disturbance and tends to become unstable.

### Experiment 1

FIG. 4 illustrates the results obtained by measuring the behavior of a weighed value at the time of stopping the pump 50 by using the system 1 while the discharge port diameter of the supply tube 52 is changed in two levels as indicated by Table 2 with respect to each of the filter settings in two levels in Table 1. More specifically, the behavior of a weighed value after the stop of the supply device was measured at the time of stopping the supply device when the flow rate of the supply device was set to 100 g/min and the weighed value reached 20 g.

TABLE 1
Characteristics of Filter Setting

| | Measurement | |
|---|---|---|
| Filter Setting | Response Speed | Display Stability |
| Strong (SLOW) | Low | Strong |
| Weak (FAST) | High | Weak |

TABLE 2
Inner Diameter of Discharge Distal End

| Discharge | Discharge Inner | |
|---|---|---|
| Distal End | Diameter (mm) | Actual Processing |
| Standard (supply | 4 | Leaving tube intact |
| pressure: | | |
| standard) | | |
| Thin (supply | 0.52 | Connecting needle |
| pressure: high) | | having inner diameter |
| | | of 0.52 mm to tube |
| | | distal end |

Note that when the flow rate is constant, changing the discharge inner diameter, i.e., the sectional area of the discharge port, means to change the supply pressure when supplying a liquid to the vessel 12.

Referring to FIG. 4, when the discharge distal end remains unchanged, a stronger filter setting increases the final value as an excessive amount. On the other hand, thinning the discharge distal end, thereby increasing the supply pressure, will reduce the final value after it temporarily becomes an excessive amount. If the filter setting is weak and the supply pressure is high, in particular, the final value becomes insufficient instead of being excessive. This indicates that a filter setting is associated with a stop weighed value deviation with respect to an excessive amount, whereas a supply pressure is associated with a stop weighed value deviation with respect to insufficiency.

### Experiment 2

As in Experiment 1, final weighed values after the stop of the supply device at a target weighed value were measured by using the system 1 with respect to the filter settings and the discharge distal ends in the two levels each shown in Table 1 and Table 2 while the flow rate was changed from 40 g/min to 100 g/min.

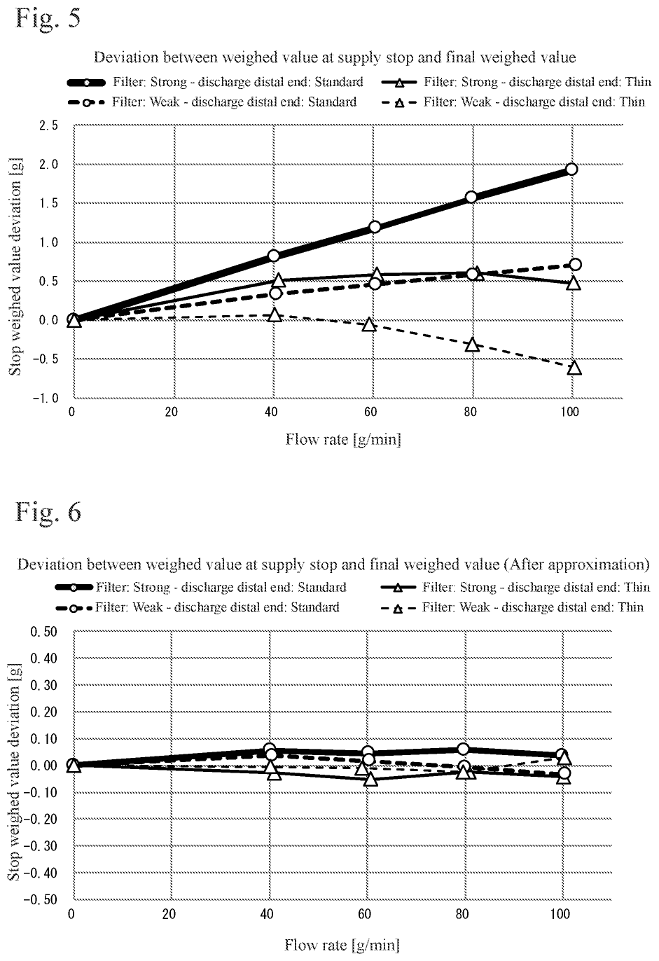

FIG. 5 illustrates the results in Experiment 2. Referring to FIG. 5, the theoretical extreme point is assumed at a stop weighed value deviation of 0 when the flow rate is 0 g/min.

The results indicate that with the standard discharge distal end indicated by ∘ (white circle), i.e., the standard supply pressure, the final weighed values increase in proportion to the flow rates, whereas with the thin discharge distal end indicated by A (white triangle), i.e., the high supply pressure, the final weighed values tend to decrease in the form of quadratic curves with increases in flow rate.

Accordingly, a stop weighed value deviation δ (δ(Q)) can be approximated by a quadratic expression of a flow rate Q like equation (1) given below by using a coefficient a associated with a supply pressure and a coefficient b associated with a filter setting.

$$δ ( 0 ) = a \cdot {Q}^{2} + b \cdot Q \qquad ( 1 )$$

In this case, the coefficients a and b are obtained from the results in FIG. 5 as indicated by Table 3 and Table 4.

TABLE 3

| Discharge Distal End | Coefficient a |
|---|---|
| Standard (standard supply | 0 |
| pressure) | |
| Thin (high supply pressure) | −1.36E−04 |

TABLE 4

| Filter Setting | Coefficient b |
|---|---|
| Strong (SLOW) | 0.0188 |
| Weak (FAST) | 0.0073 |

When the above coefficients are applied to equation (1), the stop weighed value deviation δ in the experiment in FIG. 4 becomes that illustrated in FIG. 6, thus indicating that the deviation can be properly approximated.

The operation of the pump 50 is stopped to weigh out a weighing object of a final weighed value Wₑ from the stop weighed value deviation δ(Q), obtained in the manner described above, and the final weighed value Wₑ. A supply stop weight value Wₛ can be obtained by equation (2) given below.

$${W}_{s} = {W}_{e} - δ ( Q ) \qquad ( 2 )$$

### Operation of System 1

### 1. Computation of Flow Rate Function

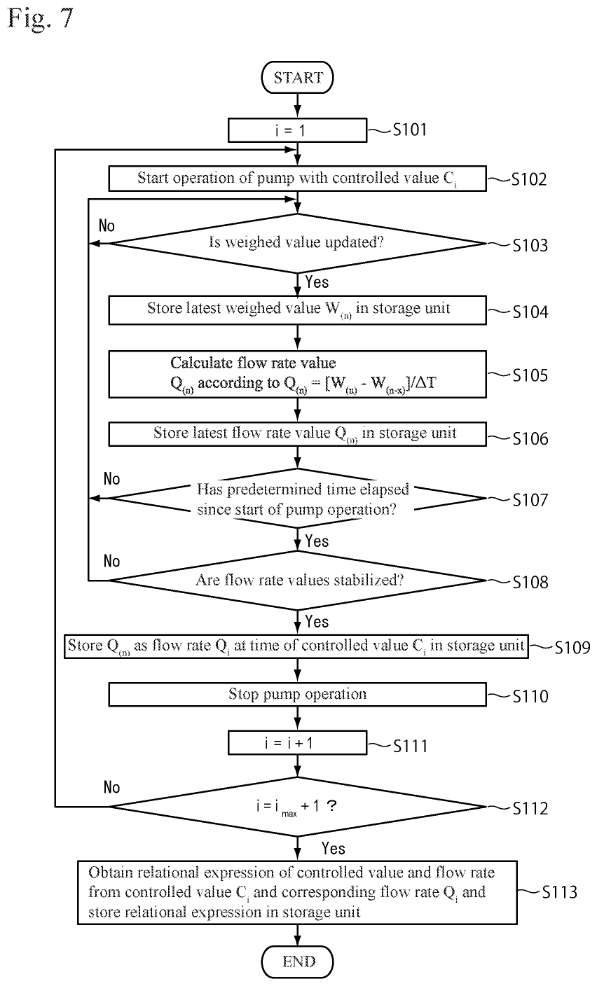

The system 1 is configured to perform analog control on the flow rate of the pump 50 with a current value serving as a controlled value C₁. Since the relationship between the controlled value Cᵢ and a flow rate Qᵢ of the pump 50 changes depending on the device used as the pump 50 or the thickness of the tube, etc., the correlation function (hereinafter referred to as “flow rate function”) between the flow rate Qᵢ and the controlled value Cᵢ needs to be obtained in advance. FIG. 7 is a flowchart for flow rate function computation processing by the flow rate function computing unit 41. The relationship between the flow rate and the controlled value for the pump based on the balance is obtained, and the relationship between the controlled value Cᵢ for the pump and the flow rate Qᵢ is stored.

The following explanation is a specific example of obtaining flow rates Q₁ to Q₃ when the controlled value Cᵢ is changed as a current value of an analog output in three levels, namely C₁ to C₃ indicated in Table 5 and storing the obtained flow rates as a function.

TABLE 5
Relationship between Controlled Value
and Current Value

| Controlled Value Cᵢ | Current Value (mA) |
|---|---|
| C₁ | 10 |
| C₂ | 16 |
| C₃ | 20 |

When the processing starts, the flow rate function computing unit 41 sets i=1 in step S101. In step S102, the flow rate function computing unit 41 starts the operation of the pump 50 and sets the controlled value to Cᵢ.

Next, in step S103, the flow rate function computing unit 41 determines whether the weighed value is updated and repeats the processing until the weighed value is updated. If the weighed value is updated (Yes), the flow rate function computing unit 41 stores the latest weighed value W₍ₙ₎ in the storage unit 25 in step S104.

Next, in step S105, the flow rate function computing unit 41 calculates a flow rate value Q₍ₙ₎ according to equation (3) given below.

$${Q}_{( n )} = [ {W}_{( n )} - {W}_{( n - X )} ] / Δ T \qquad ( 3 )$$

(where W₍ₙ₎ is the latest weighed value, W_{(n-X)} is the Xth weighed value before the latest weighed value, and ΔT is the time interval between the latest weighed value and the Xth weighed value before the latest weighed value.)

Next, in step S106, the flow rate function computing unit 41 stores the latest flow rate value Q₍ₙ₎ in the storage unit 25.

Next, in step S107, the flow rate function computing unit 41 determines whether a predetermined time that allows proper calculation of a flow rate has elapsed since the start of the operation of the pump 50 with the controlled value Cᵢ. If the predetermined time has not elapsed (No), the process returns to step S103 to repeat steps S103 to S107 until the elapse of the predetermined time. In this manner, w₍ₙ₎ W₍ₙ₋₁₎ Wₙ₋₂, . . . and Q₍ₙ₎, Q₍ₙ₋₁₎, Q₍ₙ₋₂₎, . . . are sequentially stored in the storage unit 25.

On the other hand, if the flow rate function computing unit 41 determined in step S107 that the predetermined time has elapsed (Yes), the process shifts to step S108, in which the flow rate function computing unit 41 determines whether the flow rate values Q₍ₙ₎, Q₍ₙ₋₁₎, Q₍ₙ₋₂₎, . . . are stabilized. Whether flow rate values are stabilized may be determined by determining whether the difference between the flow rate value Q₍ₙ₎ and the immediately preceding flow rate value Q₍ₙ₋₁₎ is equal to or less than a predetermined value, etc.

If the flow rate function computing unit 41 determines in step S108 that the flow rate values are not stabilized (No), the process returns to step S103. On the other hand, upon determining that the flow rate values are stabilized (Yes), the flow rate function computing unit 41 causes the storage unit 25 to store Q₍ₙ₎ as the flow rate Qᵢ at the controlled value Cᵢ in step S109.

Next, in step S110, the flow rate function computing unit 41 stops the operation of the pump 50.

Next, in step S111, the flow rate function computing unit 41 increments according to i=i+1. In step S112, the flow rate function computing unit 41 determines whether i=iₘₐₓ+1. In this case, the flow rate function computing unit 41 determines whether i=4. If not i=iₘₐₓ+1 (No), the process returns to step S102.

On the other hand, upon determining in step S112 that i=iₘₐₓ+1 (Yes), the flow rate function computing unit 41 obtains a relational expression (function) between the controlled value Cᵢ and the flow rate Qᵢ from the controlled value Cᵢ and the flow rate Qᵢ at that time in the following manner and causes the storage unit 25 to store equation (5) in step S113.

The relationship between an arbitrary controlled value Cₓ and a corresponding flow rate Qₓ can be theoretically obtained in the form of a linear expression. In practice, however, as the controlled value Cₓ is increased to increase the rotation speed of the pump, the response at the time of flattening/releasing the tube deteriorates. For this reason, the above relationship is approximated by a quadratic expression as equation (4) given below.

$${Q}_{x} = α \cdot {c}_{x}^{2} + β \cdot {c}_{x} \qquad ( 4 )$$

This makes it possible to calculate a controlled value C_{R} to achieve a desired flow rate Q_{R} according to equation (5) given below by obtaining flow rates Qᵢ corresponding to two or more controlled values Cᵢ and obtaining α and β from the obtained flow rates.

$$\begin{matrix}[ Math 1 ] & \\ {C}_{R} = \frac{- β + \sqrt{{β}^{2} + 4 \cdot α \cdot {Q}_{R}}}{2 \cdot α} & ( 5 )\end{matrix}$$

### 2. Test Mode

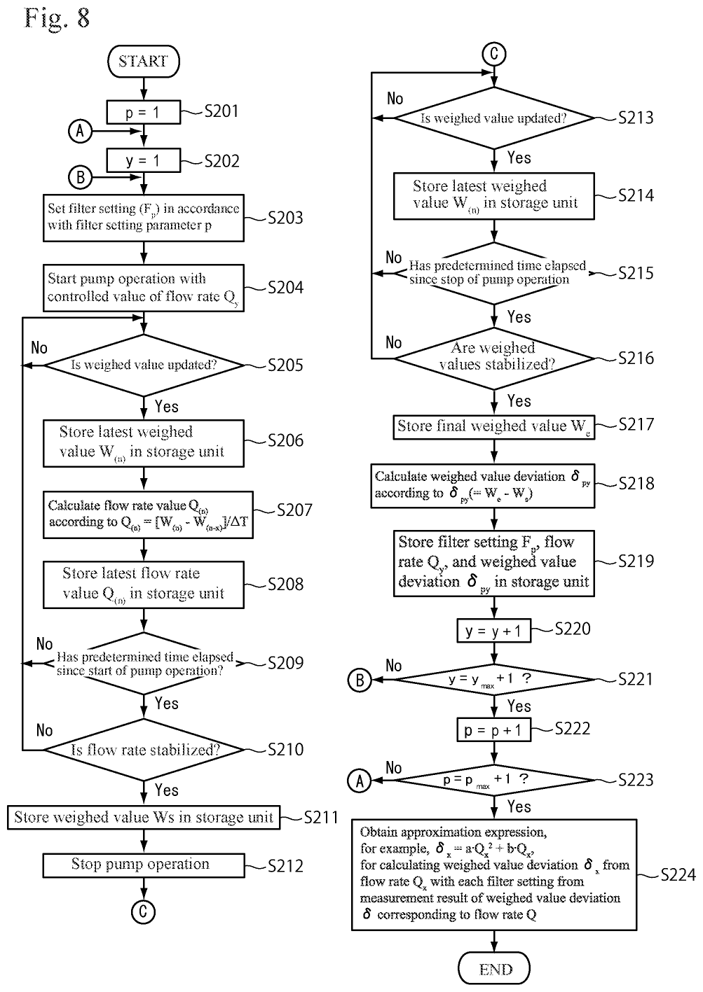

Next, the test mode will be described. As described above, the stop weighed value deviation δ is expressed as a function of the flow rate Q. In the test mode, before actual quantitative dispensing, the relationship between the stop weighed value deviations δ and the flow rates Q is measured with respect to a plurality of filter settings Fₚ and a plurality of flow rates Q_{y} and the relationship is stored. FIG. 8 is a flow chart for processing in the test mode.

The following explanation is a specific example of obtaining the relationship between a filter setting Fₚ, a stop weighed value deviation δ_{py}, and a flow rate Q_{y} by measuring flow rates in the three steps in Table 7 with respect to the filter settings in the three levels in Table 6.

TABLE 6
Filter Setting

| Filter Setting (Fₚ) | Response Speed |
|---|---|
| F₁ | fast |
| F₂ | standard |
| F₃ | Slow |

TABLE 7
Flow Rate

| Flow Rate (Q_{y}) | Flow Rate (ml/min) |
|---|---|
| Q₁ | 1 |
| Q₂ | 6 |
| Q₃ | 12 |

When the test mode is started, the test mode executing unit 42 sets a filter setting parameter p to p=1 in step S201 and sets a flow rate setting parameter y to y=1 in step S202.

Next, in step S203, the test mode executing unit 42 sets the filter setting Fₚ in accordance with the set filter setting parameter p. In step S204, the controlled value C_{y} corresponding to the flow rate Q_{y} according to the set flow rate setting parameter y is calculated by using the flow rate function calculated by the flow rate function computing unit 41, and the operation of the pump 50 is started with the controlled value C_{y}.

Next, in step S205, the test mode executing unit 42 determines whether the weighed value is updated and repeats the processing until the weighed value is updated. If the weighed value is updated (Yes), the latest weighed value W₍ₙ₎ is stored in the storage unit 25 in step S206.

Next, in step S207, the test mode executing unit 42 calculates the flow rate value Q₍ₙ₎ according to equation (3).

$${Q}_{( n )} = [ {W}_{( n )} - {W}_{( n - X )} ] / Δ T \qquad ( 3 )$$

(where W₍ₙ₎ is the latest weighed value, W_{(n-X)} is the Xth weighed value before the latest weighed value, and ΔT is e.)

Next, in step S208, the test mode executing unit 42 stores the latest flow rate value Q₍ₙ₎ in the storage unit 25.

Next, in step S209, the test mode executing unit 42 determines whether a predetermined time that allows proper calculation of a flow rate has elapsed since the start of the operation of the pump 50 with the controlled value Cᵢ. If the predetermined time has not elapsed (No), the process returns to step S205. In this manner, w₍ₙ₎, W₍ₙ₋₁₎, W₍ₙ₋₂₎, . . . and Q₍ₙ₎, Q₍₁₎, Q₍ₙ₋₂₎, . . . are sequentially stored in the storage unit 25.

On the other hand, if the predetermined time has elapsed (Yes) in step S209, the process shifts to step S210, in which the test mode executing unit 42 determines whether the flow rate values Q₍ₙ₎, Q₍ₙ₋₁₎, Q₍ₙ₋₂₎, . . . are stabilized. Whether flow rate values are stabilized may be determined by, for example, determining whether the difference between the flow rate value Q₍ₙ₎ and the immediately preceding flow rate value Q₍ₙ₋₁₎ is equal to or less than a predetermined value, etc.

If the flow rate values are not stabilized (No) in step S210, the process returns to step S205. If the flow rate values are stabilized (Yes), the process shifts to step S211, in which the test mode executing unit 42 causes the storage unit 25 to store the latest weighed value W₍ₙ₎ as the supply stop weight value Wₛ. At the same time, in step S212, the test mode executing unit 42 stops the operation of the pump 50 by setting the controlled value to 0.

Next, in step S213, the test mode executing unit 42 determines whether the weighed value is updated and repeats the processing until the weighed value is updated. If the weighed value is updated (Yes), the latest weighed value W₍ₙ₎ is stored in the storage unit 25 in step S214.

Next, in step S215, the test mode executing unit 42 determines whether a predetermined time has elapsed since the start of the operation of the pump 50. If the predetermined time has not elapsed (No), the process returns to step S213. In this manner, the weighed values W₍ₙ₎, W₍ₙ₋₁₎, W₍ₙ₋₂₎, . . . are sequentially stored in the storage unit 25.

On the other hand, upon determining in step S215 that the predetermined time has elapsed (Yes), the test mode executing unit 42 determines in step S216 whether the weighed values W₍ₙ₎, W₍ₙ₋₁₎, W₍ₙ₋₂₎, . . . are stabilized. Whether weighed values are stabilized may be determined by, for example, determining whether the difference between the weighed value W₍ₙ₎ and the immediately preceding weighed value W₍ₙ₋₁₎ is equal to or less than a predetermined value.

If the weighed values are not stabilized (No) in step S216, the process returns to step S213. On the other hand, if the weighed values are stabilized in step S216 (Yes), the test mode executing unit 42 causes the storage unit 25 to store the latest weighed value W₍ₙ₎ as the final weighed value Wₑ in step S217.

Next, in step S218, the test mode executing unit 42 calculates the stop weighed value deviation δ_{py} by using equation (6).

$${δ}_{p y} = {W}_{e} - {W}_{s} \qquad ( 6 )$$

Accordingly, since the final weighed value Wₑ means a supply target weight value Wₐ, the supply stop weight value Wₛ for weighing out the weighing object of the supply target weight value Wₐ can be calculated by using equation (7) given below.

$${W}_{s} = {W}_{a} - {δ}_{p y} \qquad ( 7 )$$

Next, in step S219, the test mode executing unit 42 associates and stores the filter setting Fₚ, the flow rate Q_{y}, and the stop weighed value deviation δ_{py} in the storage unit 25.

Next, in step S220, the test mode executing unit 42 increments the flow rate setting parameter y according to y=y+1. In step S221, the test mode executing unit 42 determines whether y=yₘₐₓ+1. In this specific example, the test mode executing unit 42 determines whether y=4.

If the flow rate setting parameter y is not y=yₘₐₓ+1 (No), the process returns to step S203. On the other hand, if the flow rate setting parameter y is y=yₘₐₓ+1 (Yes), the process shifts to step S222. In step S222, the test mode executing unit 42 increments the filter setting parameter p according to p=p+1. In step S223, the test mode executing unit 42 determines whether p=pₘₐₓ+1, that is, p=4 in a specific example.

If the filter setting parameter p is not p=pₘₐₓ+1 (No), the process returns to step S202. On the other hand, if the filter setting parameter p is p=pₘₐₓ+1 (Yes), the test mode executing unit 42 calculates an approximation expression for calculating the stop weighed value deviation δₓ from the flow rate Qₓ with each filter setting from the measurement result of the stop weighed value deviation δ with respect to the flow rate Q according to equation (1) and stores the approximation expression in the storage unit 25 in step S224. The test mode executing unit 42 then terminates the processing. In this manner, the relationship between the flow rate Q and the stop weighed value deviation δ with each filter setting is stored in the storage unit 25.

### 3. Quantitative Dispensing

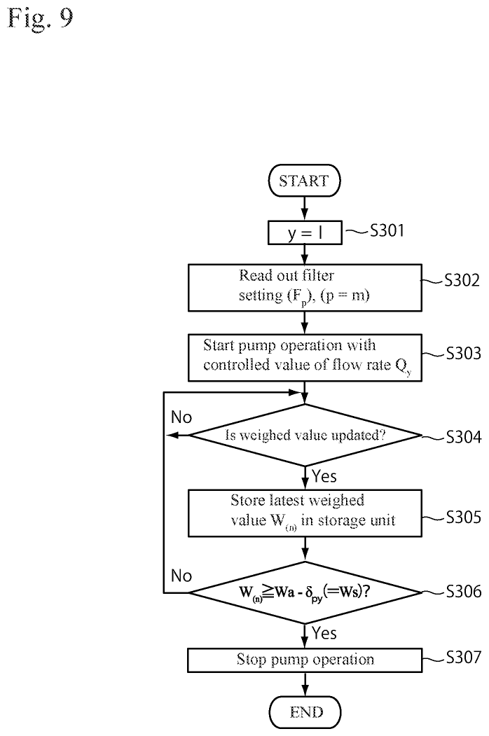

Next, quantitative dispensing processing using the system 1 will be described with reference to FIG. 9. Assume that the computation of the above flow rate function and the test mode have been executed before quantitative dispensing.

When starting quantitative dispensing, the user inputs the supply target weight value Wₐ and the desired flow rate setting Q_{y} to the system 1. In this case, the flow rate setting parameter y is set to y=1. The user can input an instruction by selection from a drop-down list or inputting an arbitrary value, etc. In addition, the filter setting Fp is set to, for example, p=m in advance in accordance with the installation environment (the influences of vibration and wind) of the balance.

Upon starting quantitative dispensing, the quantitative dispensing executing unit 43 sets the flow rate setting parameter y to y=1 based on an instruction from the user in step S301.

Next, in step S302, the quantitative dispensing executing unit 43 reads out a filter setting Fₘ set in advance.

Next, in step S303, the quantitative dispensing executing unit 43 sets a flow rate Q₁ in accordance with the flow rate parameter p set in step S301, converts the flow rate Q₁ into a controlled value C₁ by using the flow rate function obtained by the flow rate function computing unit 41, and starts the operation of the pump 50 with the controlled value C₁.

Next, in step S304, the quantitative dispensing executing unit 43 determines whether the weighed value is updated. If the weighed value is not updated (No), step S304 is repeated again. If the weighed value is updated (Yes), the quantitative dispensing executing unit 43 stores the latest weighed value W₍ₙ₎ in the storage unit 25 in step S305.

Next, in step S306, the quantitative dispensing executing unit 43 calculates the stop weighed value deviation δ_{py} at the time of p=m and y=1 according to the relational expression between the flow rate Q_{y} and the stop weighed value deviation δ_{py} acquired by the test mode executing unit 42 and compares the latest weighed value W₍ₙ₎ with the value obtained by subtracting a stop weighed value deviation δₘ₁ from the supply target weight value Wₐ, i.e., the supply stop weight value Wₛ.

If the latest weighed value W₍ₙ₎ is smaller than the supply stop weight value Wₛ (No), the process returns to step S304. On the other hand, if the latest weighed value W₍ₙ₎ is equal to or more than the supply stop weight value Wₛ in step S306, the quantitative dispensing executing unit 43 stops the operation of the pump 50 in step S307 and terminates the processing. In this manner, a weighing object of the supply target weight value Wₐ can be precisely dispensed.

In conventional quantitative dispensing apparatuses, a supply stop weight value has been set in consideration of a weighed value error based on the response delay from stop control on the supply device to the actual stop of the device and the drop of the supply tube. However, no consideration has been given to a stop weighed value deviation caused by the response delay of the measurement system which occurs in accordance with the filter setting of the balance and a supply pressure. In particular, in the quantitative dispensing system 1 according to the present embodiment, the stop weighed value deviation δ is obtained in consideration of the response delay of the measurement system and a supply pressure, thereby more accurately weighing out a predetermined amount.

Using the stop weighed value deviation δ in accordance with a flow rate and a filter setting makes it necessary to obtain the stop weighed value deviation δ every time the flow rate and the filter setting change, even if the pump to be used remains the same. The quantitative dispensing system according to the present embodiment includes the test mode for measuring the relationship between the stop weighed value deviation δ and the flow rate Q with respect to the plurality of filter settings Fₚ and the plurality of flow rates Q_{y} and storing the measured relationship and is configured to be able to calculate the stop weighed value deviation δ from a flow rate and a filter setting by using the relational expression obtained by the test mode. This makes it unnecessary for the user to calculate and set a stop weighed value deviation again every time a flow rate setting and a filter setting are performed, thereby the user can eliminate the trouble of performing setting.

In this test mode, in particular, since the relationship between the stop weighed value deviation δ and the flow rate Q is stored as a function, it is possible to handle control such as continuously changing the flow rate Q, thus providing an advantageous effect.

The quantitative dispensing system 1 according to the present embodiment is also configured to provide the electronic balance as the weighing device with the analog control unit that can perform contact output/analog output, and hence can perform analog control on the start/stop of the operation and the flow rate of the pump as the supply device without going through any external control unit. When a supply device is configured to directly perform digital control from the control unit of an electronic balance, the device is often additionally provided with an external control device that can perform digital/analog conversion. Many of the relatively compact supply devices of a tube pump type operate under analog control. Additionally providing an external control device for such a supply device will make the devices relatively expensive. Accordingly, the system 1 need not use any external control unit or can use an inexpensive analog control type supply device, and hence can achieve overall cost reduction.

### Modification

Note that the above embodiment has exemplified the case in which the weighing device controls the supply device by using analog output with a current value serving as a controlled value. However, the supply device is not limited to one that is controlled by analog output and may be one that is controlled by digital signals.

As in the above embodiment, when the supply device is to be controlled by analog output, the device is not limited to one that is controlled by a current value as a controlled value and may be one that is controlled by a voltage value as a controlled value.

The above embodiment is configured to stop the supply device when the latest weighed value W₍ₙ₎ becomes equal to or more than the supply stop weighed value Wₛ. However, a threshold for changing a flow rate may be provided for the difference between the latest weighed value W₍ₙ₎ and the supply stop weighed value Wₛ to perform control such that if the difference between the latest weighed value W₍ₙ₎ and the supply stop weighed value Wₛ is sufficiently large, the controlled value to be output is increased and the flow rate is increased, whereas if the difference between the latest weighed value W₍ₙ₎ and the supply stop weighed value Wₛ approaches the stop weighed value deviation to some extent, the controlled value to be output is reduced and the flow rate is reduced. In addition, if the difference between the latest weighed value W₍ₙ₎ and the supply stop weighed value Wₛ becomes equal to or less than the stop weighed value deviation S (the latest weighed value W₍ₙ₎ becomes equal to or more than the supply stop weighed value Wₛ), the operation of the supply device is stopped. As described above, the time required for quantitative dispensing can be shortened by changing the flow rate, i.e., the controlled value, based on the difference between the latest weighed value W₍ₙ₎ and the supply stop weighed value Wₛ.

The above embodiment has exemplified the case in which the present invention is configured as the system that dispenses a liquid as a weighing object in predetermined amounts. However, a weighing object is not limited to a liquid and may be a powder and granular material.

Although the preferred embodiments of the present invention have been described, the above embodiments are examples of the present invention. These embodiments can be combined based on the knowledge of a person skilled in the art. Such combined embodiments are also incorporated in the scope of the present invention.

### REFERENCE SIGNS LIST

1: Quantitative dispensing system
10: Electronic balance (Weighing device)
10a: Holding unit
21: Load sensor unit
24: Arithmetic processing unit
28: Analog control unit
41: Flow rate function computing unit
42: Test mode executing unit
43: Quantitative dispensing executing unit
50: Pump (Supply device)

1. A quantitative dispensing system characterized by comprising:
a supply device configured to supply a weighing object; and
a weighing device that includes a holding unit configured to hold the weighing object supplied from the supply device, a load sensor unit configured to detect a load of the weighing object supplied to the holding unit, and an arithmetic processing unit configured to sequentially calculate a weighed value of the weighing object from a detection result on the load and control an operation of the supply device,
wherein the arithmetic processing unit performs control to stop the supply device when a current weighed value becomes not less than a supply stop weight value calculated by subtracting a stop weighed value deviation from a supply target weight value, and
the stop weighed value deviation is calculated in consideration of a flow rate and a supply pressure at which the supply device supplies the weighing object and a filter setting in the weighing device.

2. The quantitative dispensing system according to claim 1, wherein the weighing device comprises a storage unit,
the arithmetic processing unit comprises a test mode executing unit configured to execute a test mode for changing a flow rate and a filter setting in a plurality of levels, measuring a stop weighed value deviation in each level, calculating a relationship between a flow rate, a filter setting in the weighing device, and a stop weighed value deviation, and storing the relationship in the storage unit, and
the arithmetic processing unit calculates a supply stop weight value based on the relationship between a flow rate calculated by the test mode executing unit, the filter setting, and the stop weighed value deviation when quantitative dispensing is executed.

3-5. (canceled)

6. The quantitative dispensing system according to claim 2, wherein a relationship between the flow rate, the filter setting in the device, and the stop weighed value deviation is stored as a function in the storage unit.

7. The quantitative dispensing system according to claim 2, wherein a relationship between the flow rate, the filter setting in the device, and the stop weighed value deviation is expressed by
$$δ ( Q ) = a \cdot {Q}^{2} + b \cdot Q$$
where δ is the stop weighed value deviation, Q is a flow rate, b is a coefficient associated with a filter setting, and a is a coefficient associated with a discharge pressure.

8. The quantitative dispensing system according to claim 1, wherein the weighing device comprises an analog control unit and the arithmetic processing unit controls the analog control unit to cause the weighing device to control the supply device by analog control.

9. The quantitative dispensing system according to claim 6, wherein a relationship between the flow rate, the filter setting in the device, and the stop weighed value deviation is expressed by
$$δ ( Q ) = a \cdot {Q}^{2} + b \cdot Q$$
where δ is the stop weighed value deviation, Q is a flow rate, b is a coefficient associated with a filter setting, and a is a coefficient associated with a discharge pressure.
